(19) United States
(12) Patent Application Publication
(10) Pub. No.: US 2024/0126096 A1
(43) Pub. Date: Apr. 18, 2024

(54) Paire de lunettes à pion de verrouillage et procédé de montage correspondant

(71) Applicant: MINIMA, LINAS (FR)

(72) Inventor: Julien DELAME, LE PLESSIS PATÉ (FR)

(21) Appl. No.: 18/339,659

(22) Filed: Jun. 22, 2023

(30) Foreign Application Priority Data
Jun. 22, 2022 (FR) FR2206212

(51) Int. Cl. G02C 1/02; G02C 1/00; G02C 13/00

(52) U.S. Cl. CPC G02C 1/02; G02C 1/10; G02C 13/001; G02C 2200/06

(57) ABSTRACT

A pair of eyeglasses comprising an eyeglass element mounted on a frame of said pair of eyeglasses or on a lens of said pair of eyeglasses, the lens or the frame comprising at least one orifice (6) provided with an introducing portion (7) for introducing the element through the orifice, the introducing portion being extended by a narrowed portion (8) for positioning the element in the lens or the frame, the pair of eyeglasses further comprising a locking peg (14) disposed in the orifice in a manner such as to extend at least through the introducing portion between the element on the one hand and the lens or the frame on the other hand in order to lock the element in the pair of eyeglasses.

A corresponding method for mounting an eyeglass element on a pair of eyeglasses.

The invention relates to a pair of eyeglasses comprising an eyeglass element associated with a locking peg.

The invention also relates to a method for mounting an eyeglass element on such a pair of eyeglasses.

### BACKGROUND OF THE INVENTION

An eyeglass frame generally comprises tenons to which the temples are secured. The tenons comprise a first end portion fastened to a front portion of the frame and a second portion at the opposite end, in line with which the temple extends.

The two end portions of the tenon may be articulated upon each other by a hinge, enabling the temple to pivot between a storage position in which the temple extends parallel to the lens and a utilization position in which the temple extends perpendicularly to the lens. Frames exist in which the temple is made integrally with the second end portion, the temple being connected to the tenon at the hinge, and frames exist in which the temple is attached to the second portion.

Conventionally, the first end portion of the tenon is force-fitted into a housing of the front part of the frame in a direction of introduction that is perpendicular to the lens. As a result, the tenon is secured to the frame at one of the principal faces of the frame.

The disadvantage is that it is then very difficult or even impossible to remove the tenon from the frame.

Over time, the purpose of eyeglasses has diversified from being solely an optical prosthesis to encompassing that of a fashion accessory intended to adorn the face of their wearer. At the same time, a very wide range of eyeglass shapes and colors has been developed.

Thus, mounting the tenon by force is no longer appropriate when a rapid change of the various elements of a pair of eyeglasses is required if one of them is not suitable.

### OBJECTIVE OF THE INVENTION

An objective of the invention is to propose an eyeglasses frame that can be dismantled more easily, and to propose a corresponding method.

### SUMMARY OF THE INVENTION

To this end, the invention provides a pair of eyeglasses comprising an eyeglass element mounted on a frame of said pair of eyeglasses or on a lens of said pair of eyeglasses, the lens or the frame comprising at least one orifice provided with an introducing portion for introducing the element through the orifice, the introducing portion being extended by a narrowed portion for positioning the element in the lens or the frame, the pair of eyeglasses further comprising a locking peg disposed in the orifice in a manner such as to extend at least through the introducing portion between the element on the one hand and the lens or the frame on the other hand in order to lock the element in the pair of eyeglasses.

Thus, in order to mount the eyeglass element, it suffices to introduce the element through the orifice at the level of the introducing portion and then to displace the eyeglass element relative to the lens or to the frame in a manner such that the eyeglass element advances into the narrowed portion of the orifice, namely the positioning portion. The locking peg is then fitted into the introducing portion in a manner such as to lock the eyeglass element in the positioning portion.

To remove the eyeglass element, it is consequently sufficient to remove the locking peg and then to displace the eyeglass element relative to the lens or to the frame in a manner such that the eyeglass element advances into the introducing portion. It is then possible to remove the eyeglass element from the frame or from the lens.

The invention thus makes it possible to mount the eyeglass element temporarily on the frame or on the lens in a simple manner.

It is therefore easy to detach the eyeglass element from the rest of the pair of eyeglasses, in particular because the eyeglass element is not force-fitted into said pair of eyeglasses.

This makes it easier to change one eyeglass element if it is not suitable for a user so that another can be disposed on the frame or the lens of the pair of eyeglasses under consideration.

Optionally, the eyeglass element is a tenon or a bridge.

Optionally, the orifice is in the shape of a keyhole.

Optionally, the positioning portion is disposed more towards the outside of the lens or the frame than the introducing portion.

Optionally, the locking peg covers at least a portion of the element protruding from a front face of the pair of eyeglasses.

Optionally, the locking peg comprises at least one housing in which the portion of the element is received.

Optionally, the locking peg comprises at least one surface that is complementary to at least one surface of the eyeglass element.

Optionally, at least a portion of the locking peg and the eyeglass element interlock with each other.

Optionally, the eyeglass element comprises a finger that is shaped to at least partially follow the shape of a lateral edge of the positioning portion.

Optionally, the element comprises a finger that is shaped to at least partially follow the shape of a lateral edge of the positioning portion.

Optionally, the locking peg comprises an attachment portion the free end of which is at least partially beveled.

Optionally, the orifice is provided in a manner such as to open onto a front face of the lens or the frame and onto a rear face of the lens or the frame.

Optionally, the orifice is open only at the front face and at the rear face. The orifice then does not open onto any of the lateral edges of the lens or the frame.

Optionally, the locking peg locks the eyeglass element in the positioning portion.

Optionally, the eyeglass element bears against at least one edge of the orifice and optionally against at least one edge of the positioning portion.

The invention also concerns a method for mounting an eyeglass element on a pair of eyeglasses as described above, the method comprising the steps of:
disposing the eyeglass element through the introducing portion,
displacing the eyeglass element along the orifice in a manner such that it extends through the positioning portion,
placing the locking peg at the level of the introducing portion.

Other characteristics and advantages of the invention will become apparent from the following description of a particular and non-limiting embodiment of the invention.

### BRIEF DESCRIPTION OF THE DRAWINGS

Reference will now be made to the accompanying drawings, in which:

FIG. 1 is an exploded perspective view of a portion of a pair of eyeglasses in accordance with a particular embodiment of the invention,

FIG. 2a schematically illustrates a first step for mounting a first eyeglass element on a pair of eyeglasses illustrated in FIG. 1,

FIG. 2b schematically illustrates a second step for mounting a first eyeglass element on a pair of eyeglasses illustrated in FIG. 1,

FIG. 2c schematically illustrates a third step for mounting a first eyeglass element on a pair of eyeglasses illustrated in FIG. 1,

FIG. 3a schematically illustrates a first step for mounting a second eyeglass element on a pair of eyeglasses illustrated in FIG. 1,

FIG. 3b schematically illustrates a second step for mounting a second eyeglass element on a pair of eyeglasses illustrated in FIG. 1,

FIG. 3c schematically illustrates a third step for mounting a second eyeglass element on a pair of eyeglasses illustrated in FIG. 1,

FIG. 4 is a perspective view of a peg of the pair of eyeglasses illustrated in FIG. 1,

FIG. 5 is a perspective view of a first variation of the pair of eyeglasses illustrated in FIG. 1,

FIG. 6 is a perspective view of a second variation of the pair of eyeglasses illustrated in FIG. 1,

FIG. 7 is a perspective view of a third variation of the pair of eyeglasses illustrated in FIG. 1,

FIG. 8 schematically illustrates two possibilities for the orientation of an orifice of the pair of eyeglasses shown in FIG. 1,

FIG. 9 schematically illustrates two possibilities for mounting an eyeglass element on the pair of eyeglasses shown in FIG. 1,

FIG. 10 is a schematic front view allowing better visualization of the cooperation between the eyeglass element and the peg of the pair of eyeglasses shown in FIG. 1,

FIG. 11 is a schematic front view proposing a first alternative to the cooperation between the eyeglass element and the peg proposed in FIG. 10,

FIG. 12 is a schematic front view proposing a second alternative to the cooperation between the eyeglass element and the peg proposed in FIG. 10,

FIG. 13 is a schematic front view proposing a third alternative to the cooperation between the eyeglass element and the pin proposed in FIG. 10,

FIG. 14a is an exploded perspective view of a fourth variation of the pair of eyeglasses illustrated in FIG. 1,

FIG. 14b is a perspective view of the pair of eyeglasses illustrated in FIG. 14a,

FIG. 15a is an exploded perspective view of a fifth variation of the pair of eyeglasses illustrated in FIG. 1,

FIG. 15b is a perspective view of the pair of eyeglasses illustrated in FIG. 15a,

FIG. 16a is an exploded perspective view of a sixth variation of the pair of eyeglasses illustrated in FIG. 1,

FIG. 16b is perspective view of the pair of eyeglasses illustrated in FIG. 16a,

FIG. 17a is an exploded perspective view of a seventh variation of the pair of eyeglasses illustrated in FIG. 1,

FIG. 17b is a perspective view of the pair of eyeglasses illustrated in FIG. 17a,

FIG. 17c is a perspective view of an alternative to the pair of eyeglasses illustrated in FIG. 17a.

### DETAILED DESCRIPTION OF THE INVENTION

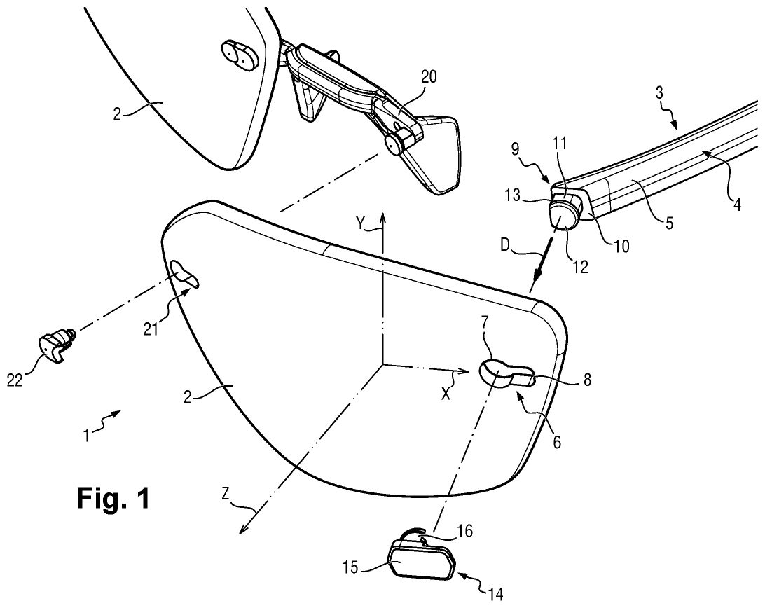

With reference to FIG. 1, a pair of eyeglasses 1 comprising two lenses 2 can be seen. The pair of eyeglasses 1 is here devoid of a frame, the two lenses 2 being connected together by at least one eyeglass element which will be described below.

It is thus possible to define a rear face and a front face for the pair of eyeglasses 1, respectively corresponding to the face turned towards the face of the wearer of the pair of eyeglasses, and the opposite face.

The lenses 2 are identical in structure, except that one is symmetrical with respect to the other about a midplane of the pair of eyeglasses 1. In the remainder of the description, only one lens will be mentioned, referring indiscriminately to one or the other of the eyeglasses.

In addition, the pair of eyeglasses 1 comprises two lateral assemblies 3 respectively connected to the right lens and to the left lens of the pair of eyeglasses. The terms “right” and “left” should be considered to refer to directions with respect to the frame of reference of the wearer of the pair of eyeglasses when wearing said pair of eyeglasses.

The lateral assemblies 3 are identical in structure, except that one is symmetrical with respect to the other about a midplane of the pair of eyeglasses. In the remainder of the description, only one assembly 3 will be mentioned, referring indiscriminately to one or the other lateral assembly.

Each lateral assembly 3 comprises a first part and a second part connected to each other. In the embodiment described, the first part is a tenon 4 and the second part is a temple (not visible here).

The tenon 4 comprises a first portion 5 and a second portion (not visible here) connected via a hinge comprising a hinge pin secured to the first portion 5, thus enabling the temple to pivot between a storage position, in which the temple extends parallel to the lens 2, and a utilization position, in which the temple extends perpendicularly to the lens 2.

An orifice 6 is formed in the lens 2 associated with the lateral assembly 3 under consideration. The orifice 6 is provided in a manner such as to be a through orifice: the orifice 6 therefore opens onto the front face and onto the rear face of the lens 2 (respectively corresponding to the front face of the pair of eyeglasses 1 and to the rear face of the pair of eyeglasses 1). Consequently, the orifice 6 passes through the thickness of the lens 2 (thickness considered along a first axis Z). The orifices 6 of the left and right lenses 2 are identical in this case, except that one is symmetrical with respect to the other about a midplane of the pair of eyeglasses 1. In the remainder of the description, only one orifice 6 will be mentioned, referring indiscriminately to one or the other orifice 6.

The orifice 6 comprises an introducing portion 7 which is extended by a narrowed portion forming a positioning portion 8. The orifice 6 therefore extends longitudinally in the lens 2 along a second axis X (which is orthogonal to the first axis Z), the positioning portion 8 extending along said second axis X in line with the introducing portion 7.

Typically, the orifice 6 is shaped in a manner such that the introducing portion 7 is situated to the right of the positioning portion 8 for the left lens 2, and/or in a manner such that the introducing portion is situated to the left of the positioning portion for the right lens 2.

By way of example, the orifice 6 may be in the shape of a keyhole.

The orifice 6 is, for example, shaped in a manner such as to extend longitudinally along the second axis X, narrowing towards an outer edge of the lens 2 (left hand edge for the left hand lens 2 and right hand edge for the right hand lens 2), i.e. towards the edge of the lens 2. The terms “outer” and “inner” should be understood to be in the context of the user's frame of reference when the pair of eyeglasses 1 is worn by the user: “outer” referring to the left and right sides of the pair of eyeglasses 1 and “inner” referring to the side facing the other lens 2.

In this example, the introducing portion 7 has a section that is at least partially circular (in a sectional plane normal to the first axis Z) and/or the positioning portion has a section that is at least partially oblong (in a sectional plane normal to the first axis Z) with a first lateral end of the positioning portion 8 opening onto the introducing portion 7. Optionally, the positioning portion 8 does not widen in the direction of its second lateral end and/or does not narrow towards its second lateral end. Thus, the positioning portion 8 preferably has two longitudinal edges that are parallel to each other and to the second axis X.

The orifice 6 is, for example, provided in the upper portion of the lens 2, the terms “upper” and “lower” being understood to be in the context of the user's frame of reference when the pair of eyeglasses 1 is worn by the user.

By way of example, the orifice 6 may be formed at the of the outer edge of the lens 2. Optionally, the orifice 6 is provided in a manner such that the positioning portion 8 is closer to the outer edge than the introducing portion 7.

The orifice 6 is therefore provided on the outer edge of the lens 2 at the upper end of said outer edge.

Optionally, when the pair of eyeglasses 1 is worn, the orifice 6 extends substantially horizontally.

It should be noted that the orifice 6 opens only onto the front and rear faces of the pair of eyeglasses 1. In particular, the orifice 6 does not open onto an outer edge of the lens 2. The cross section of the orifice 6 (normal to the first axis Z) is therefore closed. In particular, neither the positioning portion 8 nor the introducing portion 7 opens onto an outer edge of the lens 2.

The first portion 5 of the tenon 4 of the lateral assembly 3 also has means for fastening it to the remainder of the pair of eyeglasses 1, the fastening means in this case therefore forming the free end of the first portion 5. To this end, said fastening means are shaped to be received in the orifice 6.

In particular, the free end 9 of the first portion 5 of the tenon 4 of the lateral assembly 3 has an attachment zone 10 intended to come into register with the rear face of the lens 2. Preferably, the attachment zone 10 is shaped to follow the shape of the rear face of the lens 2. Preferably, the attachment zone 10 is shaped so as to rest at least in part against the rear face of the lens 2. Typically, the attachment zone 10 comprises at least one face with a curvature that is similar to that of the zone of the rear face of the lens 2 against which the attachment zone 10 is pressed. In the present case, the attachment zone 10 is a single continuous flat or curved face.

Said attachment zone 10 is extended by a finger 11 for fastening to the lens 2, the finger forming part of the aforementioned fastening means.

Said finger 11 thus extends from the attachment zone 10 in the direction away from the tenon 5. As an example, the finger 11 extends rectilinearly from said attachment zone 10 along an axis D. The attachment zone has a surface area that is greater than a cross section of the fastening finger (in a sectional plane normal to the axis D).

Here, the finger 11 is shaped so as to have a section (along a sectional plane normal to the axis D) that is at least partially rounded.

The finger 11 is shaped so as to be able to be housed in the positioning portion 8. Consequently, the section of the finger 11 has a shape that follows, at least in part, the shape of the positioning portion 8. In the present case, the section of the finger 11 is oblong in shape.

The finger 11 has a length (along the axis D) that is substantially equal to that of the thickness of the lens 2 (along the first axis Z).

The finger 11 is extended by a plate 12. Said plate 12 extends in a plane that is normal to the axis D. In a sectional plane that is normal to the axis D, the plate 12 has a section with a shape that is similar to that of the section of the finger 11. In a sectional plane that is normal to the axis D, the plate 12 has a larger sectional surface area than the finger 11. Here, the plate 12 extends parallel to the attachment zone 10.

In particular, the plate 12 is intended to come into register with the front face of the lens 2. Preferably, at least one rear principal face of the plate 12 (that is connected to the finger 11) is shaped so as to follow the shape of the front face of the lens 2. Preferably, said face is shaped so as to rest at least in part against the front face of the lens 2. Typically, said face has a curvature similar to that of the zone of the front face of the lens 2 against which the plate 12 is pressed. In the present example, the plate 12 comprises a single continuous flat or curved rear face.

The plate 12, the finger 11 and the first part 5 of the tenon 4 of the lateral assembly 3 form a complete unit. Here, the plate 12, the finger 11 and the first portion 5 of the tenon 4 of the lateral assembly 3 are in a single piece.

Preferably, the finger 11 and the plate 12 both have a flat. Typically, the finger 11 and the plate 12 have the same flat 13 which therefore extends rectilinearly along the finger 11 and the plate 12 along the axis D. As an example, the flat 13 extends from the attachment zone 10 to a free principal face of the plate 12 (opposite to the face connected to the finger 11, i.e., the rear principal face). The finger 11 and the plate 12 thus have the same planar face. Said planar face extends parallel to the axis D.

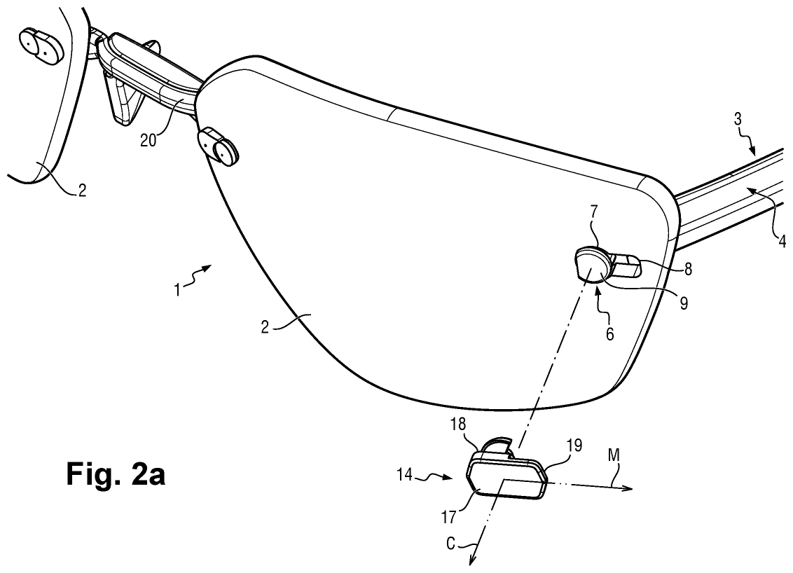

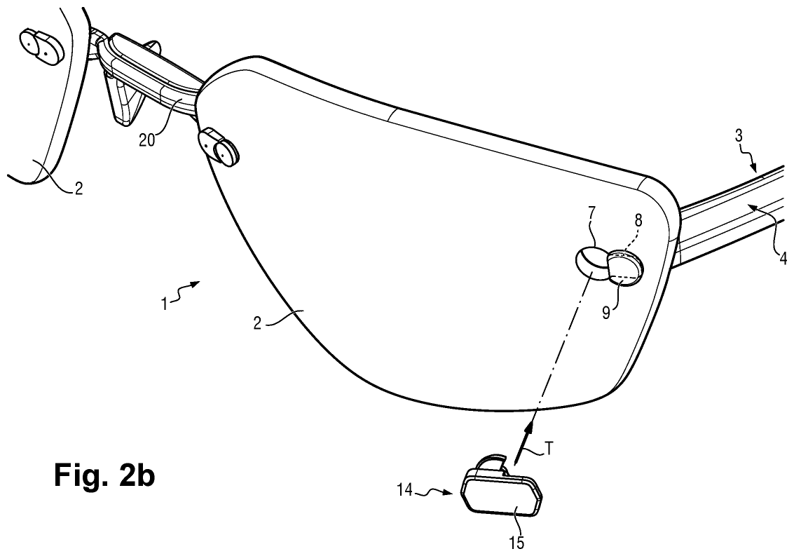

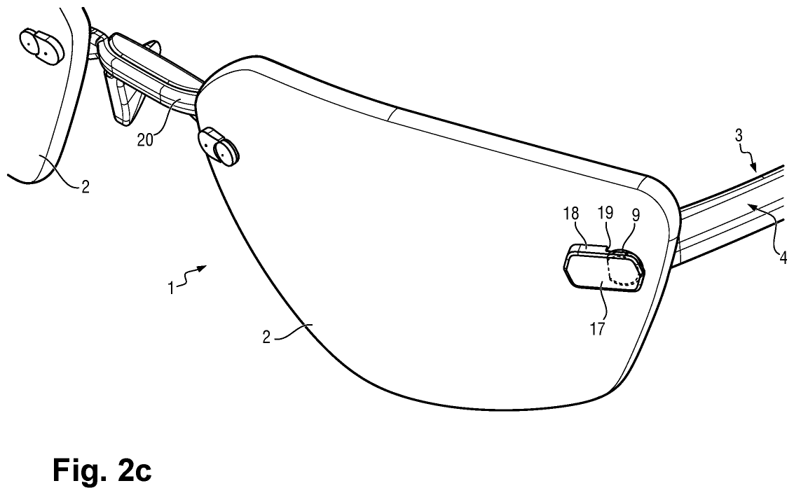

As can be seen more clearly in FIG. 2b, when the free end 9 is in place in the pair of eyeglasses 1, it extends through the orifice 6 in a manner such that the attachment zone 10 bears against the rear face of the lens 2 and the rear principal face of the plate 12 bears against the front face of the lens 2. The finger 11 extends into the orifice 6. Preferably, the finger 11 extends into the orifice 6 so that the axis D is parallel to the first axis Z.

More precisely, the finger 11 extends through the positioning portion 8 of the orifice 6. More precisely still, the finger 11 extends through the positioning portion 8 of the orifice 6 in a manner such as to come into abutment against the second lateral end of the positioning portion 8.

In this position, the flat 13 is turned towards the introducing portion 7. The remainder of the finger 11 then follows the shape of the second lateral end of the positioning portion 8.

In order to lock the free end 9 in the lens 2, the pair of eyeglasses 1 is equipped with a locking peg 14.

The locking peg comprises a cover 15 provided with an attachment portion 16. As can be seen in FIG. 2c, when the peg 14 is in place in the pair of eyeglasses 1, the attachment portion 16 extends through the orifice 6, and the cover 15 extends in front of the front face of the lens 2.

Here, the cover 15 is in the shape of a plate. The cover 15 therefore has a first principal face 17 and a second principal face 18 opposite to the first principal face 17, the attachment portion 16 extending from the second principal face 18. In the present case, the cover 15 is intended to come into register with the front face of the lens 2. Preferably, the second principal face 18 is at least partially shaped to follow the shape of the front face of the lens 2. Preferably, said second principal face 18 is shaped so as to rest at least in part against the front face of the lens 2. Typically, said second principal face 18 has at least one zone with a curvature that is similar to that of the zone of the front face of the lens 2 against which it is pressed. In the present case, the cover 15 comprises a single continuous flat or curved second principal face 18.

The first principal face 17 is therefore visible to a person looking at the wearer of the pair of eyeglasses 1.

At least the first principal face 17 is in the shape of a polygon. As an example, the first principal face 17 is shaped as a hexagon (regular or otherwise) or as a pentagon (regular or otherwise) or as a quadrangle (regular or otherwise). As an example, the first principal face 17 is in the shape of a square or a rectangle. Optionally, the angles of the first principal face 17 are rounded.

Here, the first principal face 17 is flat or curved.

The first principal face 17 here extends parallel to the second principal face 18.

Preferably, the cover 15 has a flat 19. Typically, the flat 19 is formed in the thickness of the cover 15 (thickness considered along an axis C extending between the two principal faces 17, 18—optionally, the axis C is a normal to said two principal faces 17, 18): the flat 19 opens at the level of the second principal face 18 so as to shorten it, but does not open at the level of the first principal face 17. Thus, the flat 19 is invisible to a person facing the wearer of the pair of eyeglasses 1. The flat 19 extends rectilinearly along the cover 15 along an axis M (orthogonal to the axis C). The flat 19 therefore also opens onto one of the lateral edges of the cover (the left edge for the peg associated with the left hand lens 2 and the right edge for the peg associated with the right hand lens 2).

The attachment portion 16 extends rectilinearly from the second principal face 18 along an axis T. Optionally, the axis T is a normal to the second principal face 18 and/or is coincident with the axis C.

The attachment portion 16 has a length (considered along the axis T) that is greater than that of the depth (along the first axis Z) of the orifice 6 so as to project beyond the rear face of the lens 2 when the peg 14 is in place in the orifice 6.

The attachment portion 16 here comprises at least one tab. As an example, the attachment portion comprises at least two tabs 23. Each tab 23 is in the shape of an arc of a circle. Preferably, the tabs 23 are disposed concentrically so as to jointly define a tube extending along the axis T. Since the tabs 23 are spaced apart from one another radially, the tube is therefore discontinuous. Preferably, the tube defined by the tabs 23 has a curvature that is identical to that of the introducing portion 7. Preferably, the tube defined by the tabs 23 is shaped to follow a first lateral end of the introducing portion 7 (opposite to that opening into the positioning portion 8).

The attachment portion 16 also comprises a shim 24. Here, the length of the shim 24 (considered along the axis T) is less than that of the tabs 23. Preferably, the shim 24 is closer to the flat 19 of the cover 15 than the tabs 23. Preferably, the length of the shim 24 is less than the depth (considered along the first axis Z) of the orifice 6.

Optionally, a stud 25 extends rectilinearly along the axis T from the center of the tube defined by the tabs 23 to the outside of the peg 14. The stud 25 extends coaxially with the tube defined by the tabs 23. The stud 25 extends over a length (considered along the axis T) that is less than that of the tabs 23 but more than that of the shim 24.

The shim 24 extends longitudinally along the stud 25 while being secured to said stud 25. The shim 24 is therefore integral with the stud 25. In contrast, the tabs 23 extend at a distance from the stud 25.

In the present case, only the tabs 23 and the stud 25 of the attachment portion 16 emerge from the orifice 6 via the rear face of the lens 2 when the peg 14 is in place in the pair of eyeglasses.

Optionally, the shim 24 comprises a planar portion 26 forming a portion of the flat 19 of the cover 15. Here, the planar portion 26 extends rectilinearly beyond the cover 15. The height of the flat 19 of the cover 15 (considered along the axis C) is substantially equal to the thickness of the plate 12 (considered along the axis D).

Preferably, the free end of the attachment portion 16 is at least partially beveled. The free end of the attachment portion 16 therefore has at least one zone forming a plane that is inclined with respect to the axis T.

The beveling facilitates introduction of the peg 14 into the orifice 6 once the free end has been inserted into the orifice 6.

Typically, the free end of at least one of the tabs 23 is beveled in the direction of the stud 25 and in the opposite direction of the cover 15, and/or the shim 24 comprises a curved portion 27 extending the planar portion 24 as far as the stud 25 (curved portion therefore extending in the direction of the stud 25 and in the opposite direction to the cover).

The attachment portion 16 is secured to the cover 15 and is, for example, integral with the cover 15.

As can be seen more clearly in FIG. 2c, when the peg 14 is in place in the pair of eyeglasses 1, it extends through the orifice 6 in a manner such that the first principal face 17 of the cover 14 is visible to a person looking at the wearer of the pair of eyeglasses 1, the second principal face 18 of the cover 14 bears against the front face of the lens 2, and the attachment portion 16 extends through the introducing portion 7 from the front face of the lens 2 until part of it protrudes beyond the rear face of the lens 2.

The tabs 23 are disposed facing the first lateral end of the introducing portion 7. More precisely, the attachment portion 16 extends through the introducing portion 7 so that the tabs 23 abut against the first lateral end of the introducing portion 7.

In this position, the flat 19 is turned towards the positioning portion 8 (and towards the flat 13 of the finger 11) and is optionally pressed against the flat 13 of the finger 11.

The remainder of the attachment portion 16 then follows the shape of the introducing portion 7.

The stud 25 extends along the junction between the introducing portion 7 and the positioning portion 8. The stud therefore extends along the flat 13 of the finger 11.

Furthermore, the cover 15 comes to cover the plate 12. A person looking at the wearer of the pair of eyeglasses 1 from the front therefore does not see the plate 12, because the cover 15 is covering it. More precisely here, the plate 12 is housed in the flat 19 of the cover 15 in a manner such as to be covered by at least the first principal face 17 for a person looking at the wearer of the eyeglasses 1 from the front.

Preferably, the flats 19 of the cover 15 and of the plate 12 are facing each other, or indeed they are pressed together.

This makes it easier to put the peg 16 into position.

Preferably, the peg 14 extends in the orifice 6 in a manner such that the axis M is parallel to the second axis X. Preferably, the peg 14 extends in the orifice 6 in a manner such that the axis C and/or the axis T is parallel to the first axis Z. Preferably, the peg 14 extends in the orifice 6 in a manner such that the axis C and/or the axis T is parallel to the axis D.

A description of the method for mounting the free end 9 of the first portion 5 of the tenon 4 will now be described.

With reference to FIG. 2a, during a first step, the free end 9 is inserted into the introducing portion 7 of the orifice 6 in a movement that is substantially perpendicular to the lens 2, from the rear face of the lens 2 towards the front face of the lens 2. The finger 11 here extends parallel to the first axis Z.

The free end 9 is then disposed in a manner such as to extend through the orifice 6 along the first axis Z, the attachment zone 10 resting against the rear face of the lens 2.

It should be noted that this facilitates positioning for the user, who pushes the free end 9 into the orifice 6 until the attachment zone 10 comes into abutment against the rear face of the lens 2.

In this position, the plate 12 emerges from the orifice 6 at the front face of the lens 2.

It should also be noted that the flat 13 is disposed in the orifice 6 so as to be turned towards the first lateral end of the introducing portion 7.

With reference to FIG. 2b, the free end 9 is slid into the orifice 6 until the finger 11 comes into abutment against the second lateral end of the positioning portion 8.

It should therefore be understood that the orifice 6 acts as a groove for the free end 9 and therefore facilitates its displacement from the introducing portion 7 to the positioning portion 8.

In this position, the plate 12 bears against the front face of the lens land/or the attachment zone 10 bears against the rear face of the lens 2.

This limits a relative displacement of the free end 9 of the tenon (and therefore of the temple) relative to the lens 2, in particular along the first axis Z.

As indicated above, the section of the finger 11 has a shape that follows that of the positioning portion 8, at least in part. In the present case, as can be seen more clearly in FIG. 10, the section of the finger 11 is oblong in shape, so that it has two flats (A and B) facing respective planar portions of the orifice 6.

This limits rotation of the tenon 4 in the orifice 6 along the first axis Z.

Furthermore, the finger 11 bears against the longitudinal ends and the second lateral end of the positioning portion 8.

This limits a relative displacement of the free end 9 (and thus of the temple) relative to the lens 2, in particular along the second axis X and a third axis Y (orthogonal to the first axis Z and to the second axis X).

With reference to FIG. 2c, the peg 14 is then positioned in the introducing portion 7 in a movement that is substantially perpendicular to the lens 2 from the front face of the lens 2 towards the rear face of the lens 2.

The peg 14 is then disposed in a manner such as to extend through the orifice 6 along the first axis Z, the second principal face 18 of the cover 15 resting against the front face of the lens 2.

It should be noted that this facilitates positioning for the user, who pushes the peg 14 into the orifice 6 until the second principal face 18 of its cover 15 comes into abutment against the front face of the lens 2.

This cooperation of the peg 14 with the orifice 6 on the one hand and with the free end 9 (and thus with the temple) on the other hand makes it possible to limit a displacement of said free end 9, in particular along the second axis X.

In particular, the cooperation between the flat 13 and the planar portion 26 limits a rotation of the peg 14 about its axis T in the orifice 6.

In this position, the peg 14 and the free end 9 both bear directly against at least a portion of the orifice 6. In particular, the peg 14 bears directly (i.e. without an intermediate part) against at least a portion of the introducing portion 7 and the free end 9 bears directly (i.e. without an intermediate part) against at least a portion of the positioning portion 8. In particular, the peg 14 makes it possible to press the free end 9 against at least one edge defining the orifice 6 and in the present case, it makes it possible to press the free end 9 against the lens.

Preferably, at least a portion of the peg 14 is shaped to follow the shape of a portion facing the introducing portion 7, and at least a portion of the free end 9 is shaped to follow the shape of a portion facing the positioning portion 8.

It will therefore be understood that the peg 14 locks the free end 9 in the positioning portion 8. The function of the peg 14 is therefore to block the free end 9 in the orifice 6, but not to position the peg 14 in the orifice 6. In fact, as can be seen in FIG. 2b, the free end 9 is positioned alone in the positioning portion 8 without the need for the peg 14 to bear it. Similarly, the peg 14 is positioned alone in the positioning portion 8 without the need for the free end 9 to bear it.

It will therefore be understood that both the free end 9 and the peg 14 are held independently of each other in the orifice 6. The cooperation of these two parts merely makes it possible to lock them in position in the orifice 6.

Mounting the free end 9 is therefore simple and rapid.

In addition, this mounting is reversible since it suffices to remove the peg 14 and to displace the free end 9 from the positioning portion 8 to the introducing portion 7 in order to remove it from the pair of eyeglasses 1.

Referring again to FIG. 1, it will be understood that what has been stated above in respect of the tenon (and therefore the temple) is equally applicable to another eyeglass element such as the bridge 20, i.e. the portion resting on the user's nose. In the present case, the bridge 20 is the eyeglass element 1 which also serves to interconnect the two lenses.

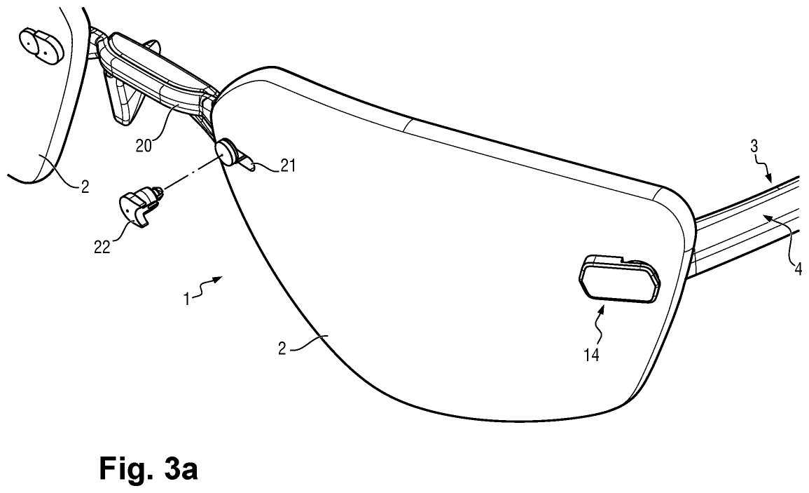

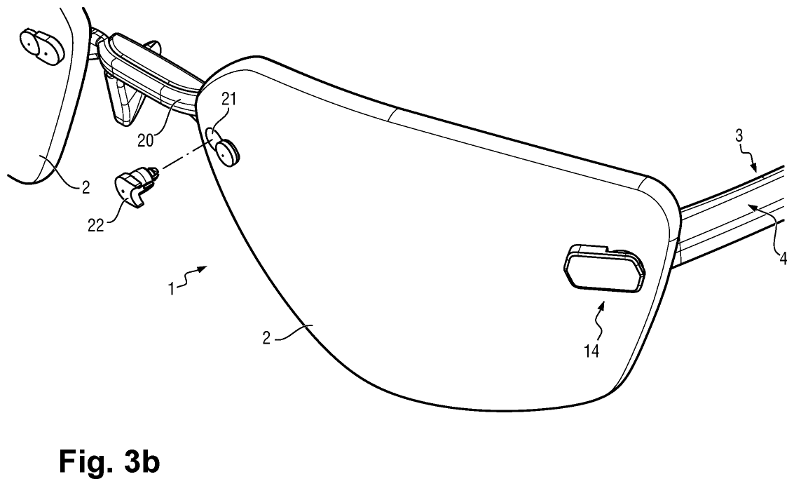

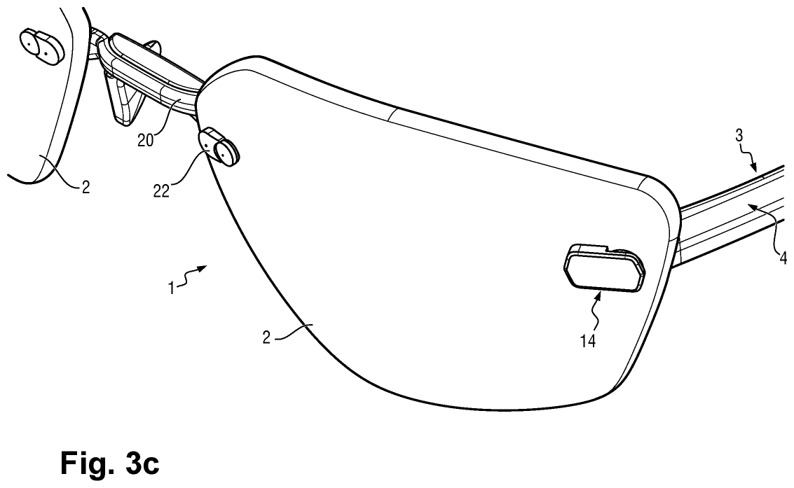

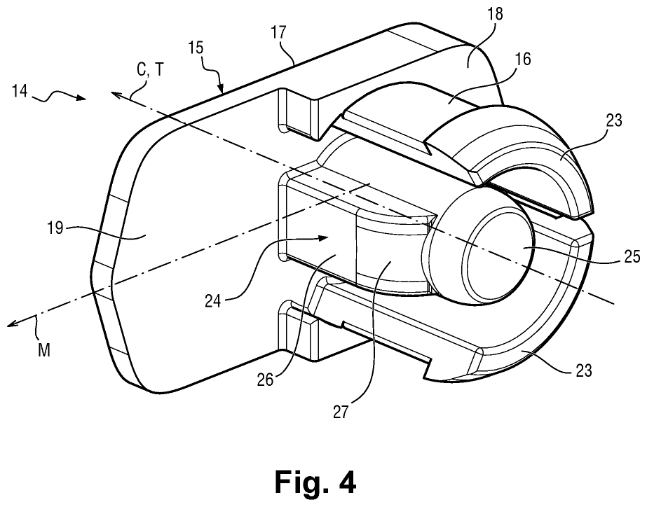

In this way, as illustrated in FIG. 3a, during a first step, the end of the bridge 20 is inserted into the introducing portion of an orifice 21 (identical in the present case to that provided for the tenon and oriented in the same way) using a movement that is substantially perpendicular to the lens 2 from the rear face of the lens 2 towards the front face of the lens 2.

With reference to FIG. 3b, the end of the bridge 20 is slid into the orifice 21 until the end of the bridge comes into abutment against the lateral end of the positioning portion of the orifice.

With reference to FIG. 3c, the peg 22 is then positioned in the introducing portion of the orifice 21 in a movement that is substantially perpendicular to the lens 2 from the front face of the lens 2 towards the rear face of the lens 2.

The cooperation of the end of the bridge 20 with the peg 14 and the orifice 21 thus makes it possible to lock the bridge 20 in position in the pair of eyeglasses.

Clearly, the invention is not limited to the embodiment described, but encompasses any variation which falls within the scope of the invention as defined by the claims.

In particular, the shape of the peg and/or of the orifice and/or of the eyeglass element could be different from that indicated.

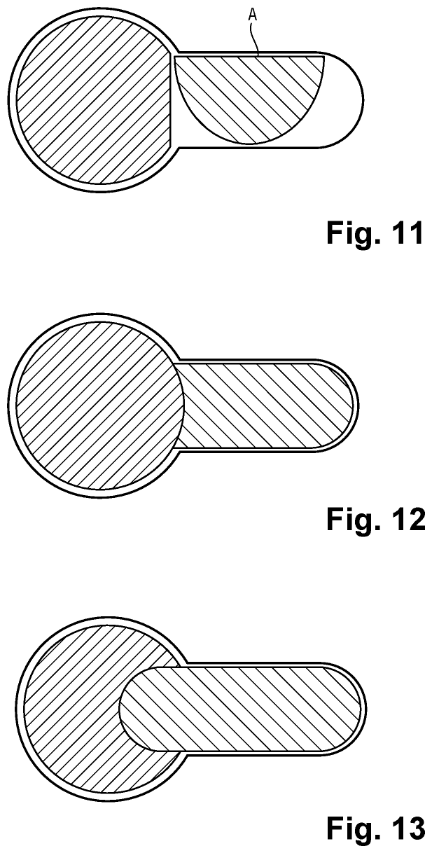

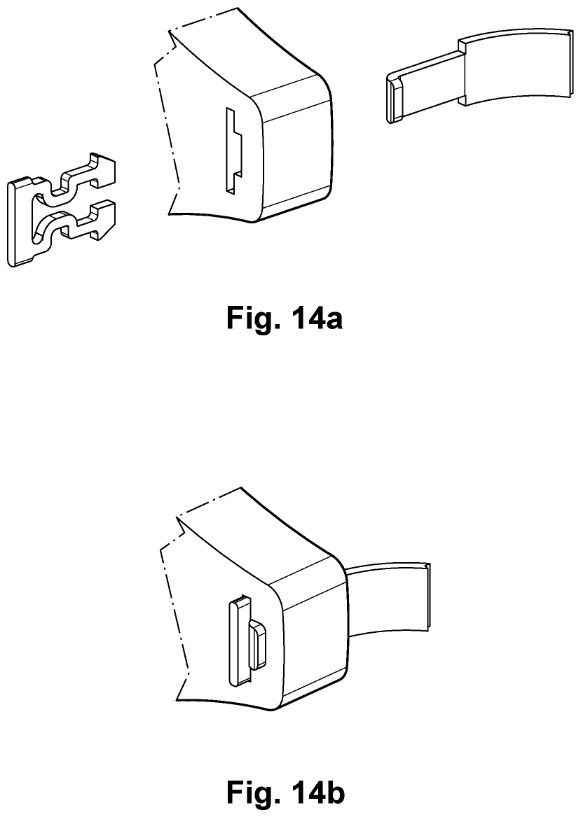

As an example, with reference to FIGS. 14a and 14b, the free end in fact has a finger extended by a plate as in the embodiment described above. However, the finger is now shaped into a first tab and the plate into another tab of smaller dimensions. At least one of the tabs may be formed or fabricated from a sheet such as a metal sheet. Similarly, while the orifice still comprises the introducing portion and the positioning portion, the section of the orifice (in a sectional plane normal to the first axis Z) is such that the introducing portion has an at least partially rectangular section, and the positioning portion has an at least partially rectangular section with a first lateral end of the positioning portion opening into the introducing portion, the positioning portion having smaller dimensions than the introducing portion. Similarly, the attachment peg has a shape that is more linear than that described above. As an example, the attachment peg is generally in the form of a plate the principal faces of which are intended to extend through the orifice. The plate is, for example, formed or manufactured from a sheet such as a metal sheet. The cover of the attachment peg forms the front of the plate and the attachment portion forms the rear and the sides of the plate. By way of example, the attachment portion comprises at least one snap-fastening claw adapted to extend through the orifice for locking at the rear of the pair of eyeglasses, and preferably at least two such claws together forming a snap-fastening clip. The orientation of the orifice is vertical in FIGS. 14a and 14b, but this is clearly not limiting, and the orientation of the orifice could be horizontal.

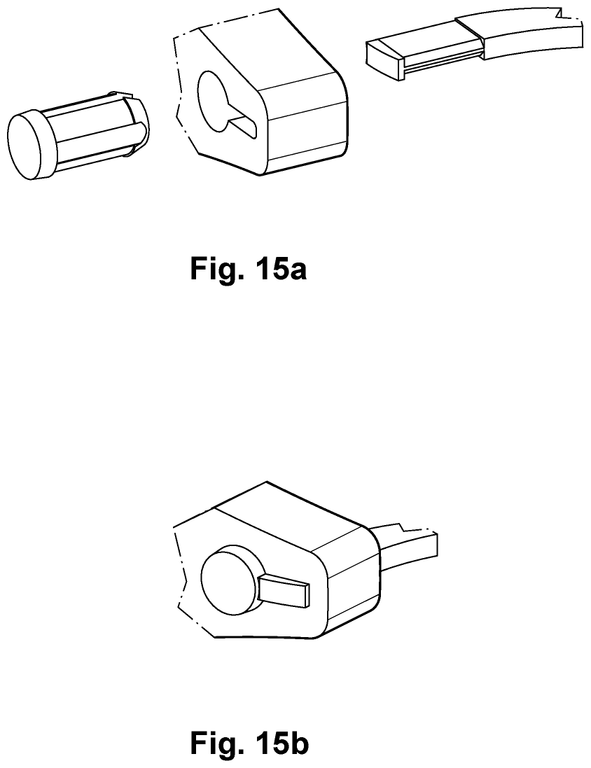

As an example, with reference to FIGS. 15a and 15b, the free end in fact has a finger extended by a plate as in the embodiment described. However, the finger is then shaped into a first tab and the plate into another tab of smaller dimensions. At least one of the tabs may be formed or fabricated from a sheet such as a metal sheet. Similarly, while the orifice still comprises the introducing portion and the positioning portion, the section of the orifice (in a sectional plane normal to the first axis Z) is such that the introducing portion has an at least partially circular section, and the positioning portion has an at least partially rectangular section with a first lateral end of the positioning portion opening onto the introducing portion, the positioning portion having smaller dimensions than the introducing portion. The attachment peg has a cover with a circular section. The attachment peg is produced from a plastics material. The orientation of the orifice is horizontal in FIGS. 15a and 15b, but this is obviously not limiting and the orientation of the orifice could be vertical.

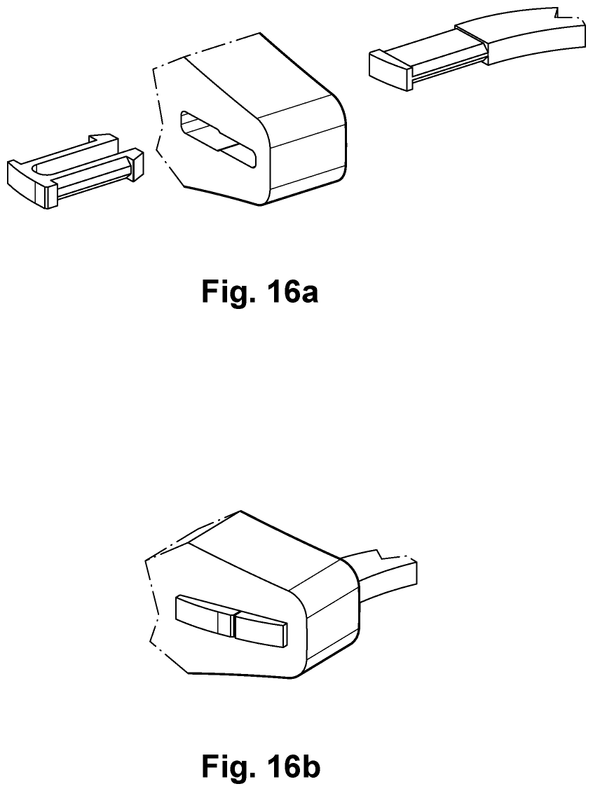

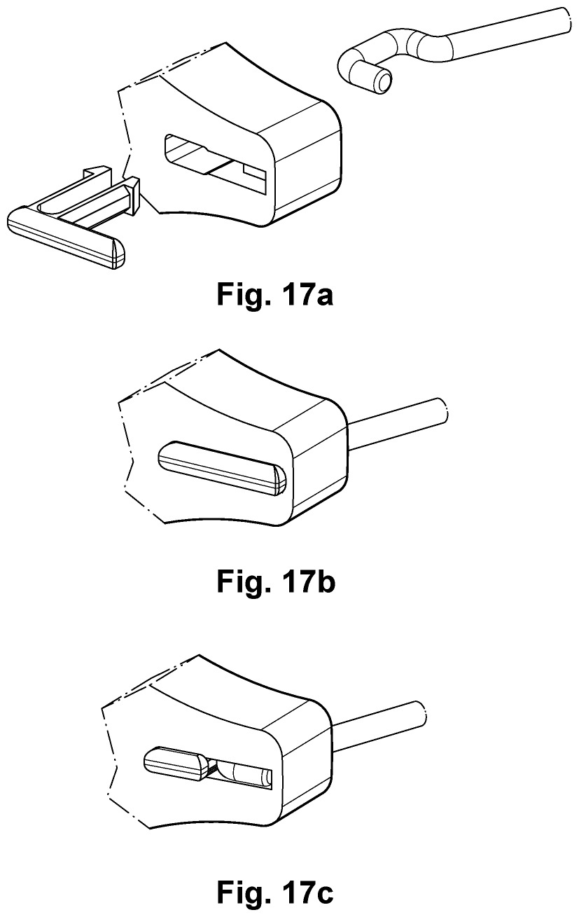

FIGS. 16a and 16b illustrate a variation similar to that associated with FIGS. 17a and 17b, except for the following differences:
the orientation of the orifice is horizontal rather than vertical, the positioning portion being disposed in line with the introducing portion along the axis X;
the at least one snap-fastening claw of the attachment peg is straight and not zigzagged.

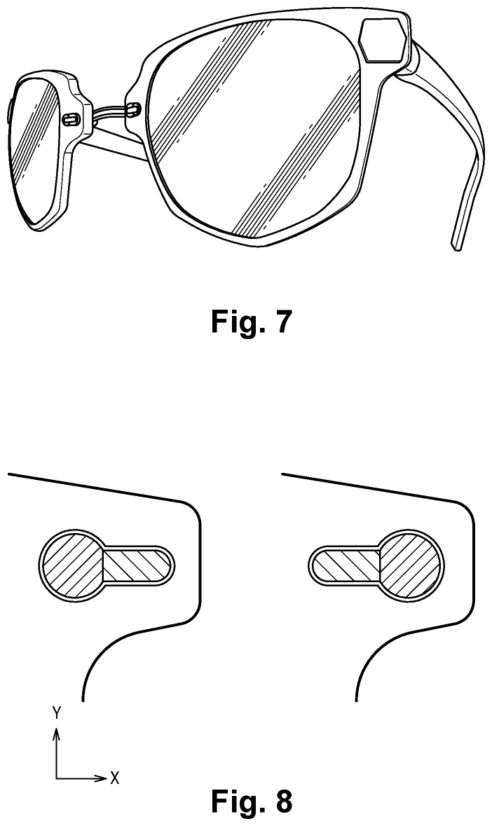

As an example, with reference to FIGS. 17a to 17c, the free end is in the form of a claw. Similarly, while the orifice still comprises the introducing portion and the positioning portion, the section of the orifice (in a sectional plane normal to the first axis Z) is such that the introducing portion has an at least partially rectangular section, and the positioning portion has an at least partially rectangular section with a first lateral end of the positioning portion opening onto the introducing portion, the positioning portion having smaller dimensions than the introducing portion. The orifice is further provided with a base extending in at least a portion of the positioning portion, the free end surrounding the base so as to be held in the position. Similarly, the attachment peg has a shape that is more linear compared with that described above. As an example, the attachment peg is generally in the form of a plate the principal faces of which are intended to extend through the orifice. The plate is, for example, formed or fabricated from a sheet such as a metal sheet. The cover of the attachment peg forms the front of the plate and the attachment portion forms the rear and the sides of the plate. By way of example, the attachment portion comprises at least one snap-fastening claw adapted to extend through the orifice for locking at the rear of the pair of eyeglasses, and preferably at least two such claws, together forming a snap-fastening clip. The claw may be straight or zig-zagged. The cover may completely cover the attachment end at the front face of the pair of eyeglasses (as illustrated in FIG. 17b) or only partially, or it may not cover the attachment end at the front face of the pair of eyeglasses (as illustrated in FIG. 17c). The orientation of the orifice is horizontal in FIGS. 17a to 17c, but this is obviously not limiting, and the orientation of the orifice could be vertical. Although the pair of eyeglasses does not have a frame here, the pair of eyeglasses could comprise a frame. The eyeglass element could then be carried either by the lens or by the frame. If the eyeglass element is carried by the frame, the orifice associated with the eyeglass element will then be provided directly in the frame so as to pass through said frame. All of the above statements regarding mounting the element directly on the lens are therefore applicable to the embodiment in which the element is mounted directly on the frame. FIG. 7 therefore illustrates such a pair of eyeglasses for which the temple is mounted on the frame by means of a locking peg.

Irrespective of whether the pair of eyeglasses comprises a frame or does not comprise a frame, the pair of eyeglasses may include two lenses, or in fact a single lens. In both cases, the eyeglass element could be carried by the lens or by the frame (if the pair of eyeglasses has one).

If it is the frame that carries the element, the orifice will then be formed in the latter and no longer in the lens directly. FIG. 7 illustrates such a pair of eyeglasses.

The orifice could have a shape other than that indicated. As an example, the introducing portion could be shaped as an oval, rectangular section (as in FIGS. 14a and 14b, in FIGS. 16a and 16b, in FIGS. 17a and 17b and 17c), oblong section, etc., and/or the positioning portion could be shaped as an oval, rectangular section (as in FIGS. 14a and 14b and in FIGS. 15a and 15b, in FIGS. 16a and 16b, in FIGS. 17a and 17b and 17c), oblong section, etc.

The orientation of the orifice could also be different from that indicated. As an example, the orifice could extend (irrespective of whether a tenon or a bridge is being mounted) so that the introducing portion is to the right of the positioning portion, or in fact it could extend in a manner such that the introducing portion is to the left of the positioning portion. FIG. 8 therefore illustrates two possibilities for the orientation of the orifice. As an example, the orifice could extend substantially vertically (when the pair of eyeglasses is worn by the user) instead of extending substantially horizontally as described above. Here again, the introducing portion could extend above the positioning portion or below it. The orifice could extend substantially obliquely (when the pair of eyeglasses is worn by the user), it being possible for the introducing portion to be closer to an outer edge of the pair of eyeglasses than the positioning portion, or further away.

Although in this example, the cover has a cross section in the form of a polygon, the cross section could have some other shape, for example oblong or circular. If the section is a polygon, it can still have a shape that differs from a quadrangle and, for example, be shaped as a triangle, a hexagon, etc. Irrespectively of the shape of the cross section, it could have at least one rounded angle.

Although in this case the peg comprises a cover that completely obscures the free end of the eyeglass element on the front face side of the lens, the cover may be shaped so as to cover only part of said free end (on the front face side of the lens) as illustrated in FIG. 15b, for example, or it could be shaped so as not to cover said free end (on the front face side of the lens), as shown in FIG. 14b or in FIG. 17c, for example.

The attachment portion could be shaped differently from that indicated. As an example, the attachment portion could comprise a snap-fastening claw, a rod extended by a foldable return in a manner such as to extend either into the extension of the rod or obliquely or perpendicularly to the rod, etc., the claw and/or the rod being intended to remain in the orifice in order to lock the free end of the eyeglass element in position by coming to bear against the rear face of the lens in order to secure the assembly (in the case of the rod, it is its return which comes to bear against the rear face of the lens in order to secure the assembly).

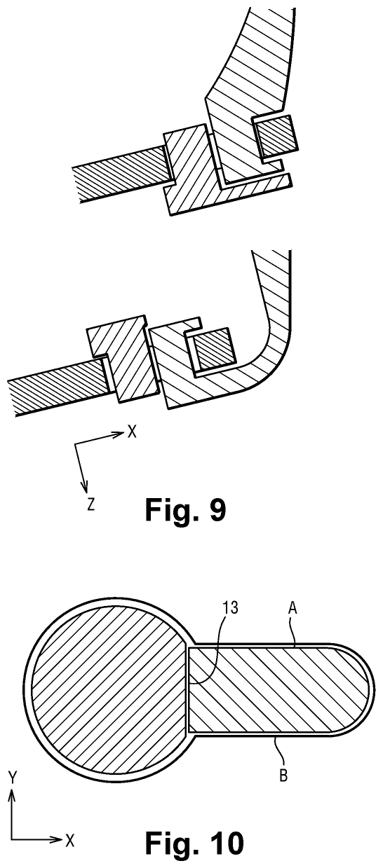

Although here the eyeglass element is mounted via the rear face of the lens (and the associated peg via the front face of the lens), the mounting could be reversed. The eyeglass element would then be introduced into the orifice from the front face of the lens in the direction of the rear face of the lens, and the peg would be introduced into the orifice from the rear face of the lens in the direction of the front face of the lens. FIG. 9 therefore illustrates the two mounting possibilities which have just been described.

The tenon and/or the temple and/or the bridge could be produced from different materials such as synthetic material, plastics material, metallic material, etc.

Similarly, the frame, if it exists, could be produced from different materials, such as synthetic material, plastics material, metallic material, etc.

Similarly, the peg could be produced from different materials such as synthetic material, plastics material, metallic material, etc.

The peg could be produced from the same material as the associated eyeglass element, or in fact it could be produced from some other material.

The frame, if it exists, could surround the outside of the lens or lenses or could only partially surround the lens or lenses.

The eyeglass frame may comprise only one lens.

The eyeglass element could be a bridge, a temple, a tenon, a lateral assembly, etc.

The peg will be held in place in the orifice without any additional fastening means, for example either by being snap-fastened therein, or simply by fitting it in. In a variation or in addition, the peg could be held in place in the orifice via additional fixing means such as a screw and nut assembly, for example. In a variation, or in addition, a free end of the peg could be shaped to co-operate with an element preventing the peg from being withdrawn from the orifice. As an example, the free end of the peg could be threaded so as to co-operate with a nut (for example introduced via the rear face of the lens) mounted on the peg once it is in place in the orifice—the nut then preventing the peg from being withdrawn from the orifice. It should be understood that in all cases, both the eyeglass element and the peg are mounted on the pair of eyeglasses in a removable manner.

Although in this case the peg and the eyeglass element have facing flats, the peg and the eyeglass element could comprise other facing surfaces. The peg and the eyeglass element could therefore comprise complementary surfaces so that the peg and the eyeglass element at least partially interlock when the peg and the eyeglass element are in place in the orifice. FIG. 12 therefore proposes an arrangement in which the peg has a section (in a sectional plane along the axis T) that is externally circular and the facing portion of the eyeglass element comprises a channel making it possible to house said peg. FIG. 13 therefore proposes an arrangement in which the peg has a section (in a sectional plane along the axis T) having a channel in which a rounded portion facing the eyeglass element is housed. The eyeglass element could therefore have a section at the orifice that is entirely oblong.

The peg and the eyeglass element might not comprise complementary surfaces. The peg could thus be shaped so as to be free to rotate about its axis T. as an example, the peg could have a section (in a sectional plane along the axis T) that is outwardly circular. The peg could therefore be devoid of a shim and/or the shim could be devoid of a flat portion and/or the peg could be devoid of a flat portion.

Although the orifice and the eyeglass element have one or more complementary surfaces here, the orifice and the eyeglass element could comprise other facing surfaces. As an example, as can be seen in FIG. 11, the element could be shaped in a manner such that its section at the orifice (in a sectional plane along the Z axis) has a single zone that follows that of the orifice. As an example, said zone could be a flat A following the corresponding planar portion of the orifice. By way of example, the zone opposite the flat could be in the form of an arc of a circle. It will be understood that for the comfort of the person wearing the pair of eyeglasses, care will be taken to ensure that the eyeglass element cannot rotate freely in the orifice about the axis Z once the peg is in place.

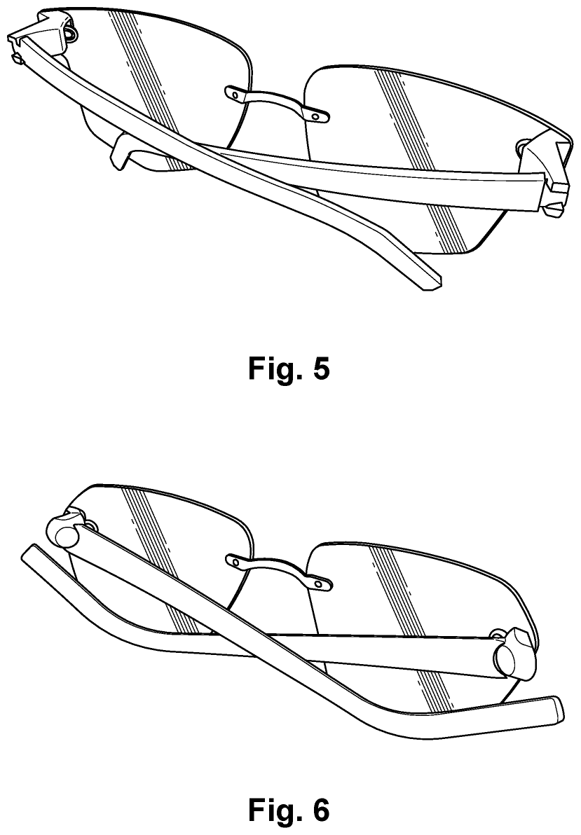

If the eyeglass element is a temple, said temple could be a single piece with the second part of the tenon, the temple connecting to the tenon at the level of the hinge. Such a pair of eyeglasses is illustrated in FIG. 5. In a variation, the temple will be attached to the second portion. In a further variation, the temple and the tenon will be in a single piece. There will then be no hinge enabling the temple to be folded down. In a variation, said portion forming a joint temple and tenon could be sufficiently flexible to carry out the hinge function intrinsically. If a hinge function is present in the pair of eyeglasses, the temple can then be folded by a rotational movement about an axis, or it could be folded in another movement, for example a movement combining at least two rotations or a rotation and a translation. The pair of eyeglasses could therefore have a hinge such as that described, for example, by the present Applicant in application FR 2 844 062.

1. A pair of eyeglasses (1) comprising an eyeglass element (3, 20) mounted on a frame of said pair of eyeglasses or on a lens of said pair of eyeglasses, the lens or the frame comprising at least one orifice (6, 21) provided with an introducing portion (7) for introducing the element through the orifice, the introducing portion being extended by a narrowed portion (8) for positioning the element in the lens or the frame, the pair of eyeglasses further comprising a locking peg (14, 22) disposed in the orifice in a manner such as to extend at least through the introducing portion between the element on the one hand and the lens or the frame on the other hand in order to lock the element in the pair of eyeglasses.

2. The pair of eyeglasses as claimed in claim 1, in which the eyeglass element is a tenon (5) or a bridge (20).

3. The pair of eyeglasses as claimed in claim 1 or claim 2, in which the orifice (6) is in the shape of a keyhole.

4. The pair of eyeglasses as claimed in one of claims 1 to 3, in which the positioning portion (8) is disposed further towards the outside of the lens or the frame than the introducing portion (7).

5. The pair of eyeglasses as claimed in one of claims 1 to 4, in which the locking peg (14) covers at least a portion of the eyeglass element protruding from a front face of the pair of eyeglasses.

6. The pair of eyeglasses as claimed in claim 5, in which the locking peg (14) comprises at least one housing in which the portion of the element is received.

7. The pair of eyeglasses as claimed in one of claims 1 to 6, in which the locking peg (14, 22) comprises at least one surface that is complementary to at least one surface of the eyeglass element.

8. The pair of eyeglasses as claimed in claim 7, in which at least a portion of the locking peg (14, 22) and the eyeglass element interlock with each other.

9. The pair of eyeglasses as claimed in one of claims 1 to 8, in which the eyeglass element comprises a finger (11) shaped to at least partially follow the shape of a lateral edge of the positioning portion (8).

10. A method for mounting an eyeglass element on a pair of eyeglasses as claimed in one of the preceding claims, the method comprising the steps of:
disposing the eyeglass element through the introducing portion,
displacing the eyeglass element along the orifice in a manner such that it extends through the positioning portion (8),
placing the locking peg (14, 21) at the level of the introducing portion.
